(19) United States
(12) Patent Application Publication
(10) Pub. No.: US 2024/0415061 A1
(43) Pub. Date: Dec. 19, 2024

(54) LAWN CARE VEHICLE WITH IMPROVED SEAT ISOLATION

(71) Applicant: HUSQVARNA AB, Huskvarna (SE)

(72) Inventors: Ryan Copping, Charlotte, NC (US); Kenneth Mandeville, Midland, NC (US); David Estey, Huntersville, NC (US); Adam Schoonmaker, Monroe, NC (US); Lee Williams, Charlotte, NC (US)

(21) Appl. No.: 18/703,544

(22) PCT Filed: Oct. 22, 2021
(86) PCT No.: PCT/US2021/056206

§ 371 Date: Apr. 22, 2024

(51) Int. Cl. A01D 67/04; A01D 101/00; B60N 2/50; B60N 2/54

(52) U.S. Cl. CPC A01D 67/04; B60N 2/502; B60N 2/505; B60N 2/507; B60N 2/544; A01D 2101/00

(57) ABSTRACT

A riding lawn care vehicle (10) may include a frame (60, 130) to which wheels (31, 32) of the riding lawn care vehicle (10) may be attachable, a seat (20, 110, 310) which an operator of the riding lawn care vehicle (10) may utilize when operating the riding lawn care vehicle (10), a seat mounting structure (120, 320) to which the seat (20, 110, 310) may be mounted, an isolation assembly (140, 340) which may provide vibration isolation between the frame (60, 130) and the seat mounting structure (120, 320), and a hinge assembly (150, 350) which may enable the seat (20, 110, 310) to pivot via the seat mounting structure (120, 320). The isolation assembly (140, 340) may include a motion ratio adjustment assembly (160, 360) which may define a motion ratio of the isolation assembly (140, 340) independent of an amount of pre-loaded compression. The isolation assembly (140, 340) may be operably coupled to the seat mounting structure (120, 320) via the hinge assembly (150, 350) such that displacement of the seat (20, 110, 310) may be transferred to the isolation assembly (140, 340) via the hinge assembly (150, 350).

### TECHNICAL FIELD

Example embodiments generally relate to lawn care vehicles and, more particularly, to riding lawn care vehicles with a fully isolated seat that is also hingedly attached to improve space utilization.

### BACKGROUND

Lawn care tasks are commonly performed using various tools and/or machines that are configured for the performance of corresponding specific tasks. Certain tasks, like grass cutting, are typically performed by lawn mowers. Lawn mowers themselves may have many different configurations to support the needs and budgets of consumers. Walk-behind lawn mowers are typically compact, have comparatively small engines, and are relatively inexpensive. Meanwhile, at the other end of the spectrum, riding lawn mowers, such as lawn tractors, can be quite large. Riding lawn mowers can sometimes also be configured with various functional accessories (e.g., trailers, tillers, and/or the like) in addition to grass cutting components. Riding lawn mowers provide the convenience of a riding vehicle as well as a typically larger cutting deck as compared to a walk-behind model.

Riding lawn mowers typically include a seat on which the operator sits while operating the vehicle. Since riding lawn mowers are often preferred for larger jobs, the provision of the seat is, at least in part, for the comfort of the operator. However, if the seat is not isolated from the bumps or oscillations associated with traversing uneven terrain (or even engine vibrations), it can become uncomfortable for the operator.

To address this problem, seat isolation systems have been provided to dampen or inhibit vibrations from reaching the seated operator. However, such isolation systems have typically suffered from being limited in their performance by virtue of employing strategies that are limiting in one way or another. Often, traditional seat isolation systems may allow for adjustment by way of changing an amount of pre-load on a spring within the isolation system. For operators on either extreme end of the spectrum of operator size, this traditional method of adjustment involving pre-loading a spring is inadequate on its own. Thus, a system for further adjustment of the isolation system is necessary in many cases.

### BRIEF SUMMARY OF SOME EXAMPLES

In one example embodiment, an isolation assembly enabling vibration isolation for a seat of a riding lawn care vehicle is provided. The isolation assembly may include a motion ratio adjustment assembly to define a motion ratio of the isolation assembly independent of an amount of pre-loaded compression, and a seat interface configured to transfer displacement of the seat to the motion ratio adjustment assembly. The seat may be operably coupled to a seat mounting structure. The isolation assembly may be operably coupled to the seat mounting structure via a hinge assembly such that displacement of the seat may be transferred to the isolation assembly via the hinge assembly.

In another example embodiment, a riding lawn care vehicle may be provided. The riding lawn care vehicle may include a frame to which wheels of the riding lawn care vehicle may be attachable, a seat which an operator of the riding lawn care vehicle may utilize when operating the riding lawn care vehicle, a seat mounting structure to which the seat may be mounted, an isolation assembly which may provide vibration isolation between the frame and the seat mounting structure, and a hinge assembly which may enable the seat to pivot via the seat mounting structure. The isolation assembly may include a motion ratio adjustment assembly which may define a motion ratio of the isolation assembly independent of an amount of pre-loaded compression. The isolation assembly may be operably coupled to the seat mounting structure via the hinge assembly such that displacement of the seat may be transferred to the isolation assembly via the hinge assembly.

### BRIEF DESCRIPTION OF THE SEVERAL VIEWS OF THE DRAWING(S)

Having thus described some embodiments of the present invention in general terms, reference will now be made to the accompanying drawings, which are not necessarily drawn to scale, and wherein:

FIG. 1A illustrates a perspective view of a riding lawn care vehicle according to an example embodiment;

FIG. 1B illustrates a top view of the riding lawn care vehicle according to an example embodiment;

FIG. 2 illustrates a block diagram of a seat isolation system according to an example embodiment;

FIG. 3 illustrates a block diagram of a motion ratio adjustment assembly according to an example embodiment;

FIG. 4A illustrates a rear perspective view of the seat isolation system according to an example embodiment;

FIG. 4B illustrates a front perspective view of the seat isolation system in accordance with an example embodiment;

FIG. 4C illustrates a rear perspective view of the seat isolation system according to an example embodiment in which the seat has been removed for illustrative purposes;

FIG. 5 is a side view of a motion ratio adjustment assembly according to an example embodiment;

FIG. 6A is a side view of a motion ratio adjustment assembly according to an example embodiment in which the mounting assembly has been removed for illustrative purposes;

FIG. 6B is a side view of a motion ratio adjustment assembly according to an example embodiment in which the mounting assembly has been removed for illustrative purposes;

FIG. 6C is a side view of a motion ratio adjustment assembly according to an example embodiment in which the mounting assembly has been removed for illustrative purposes; and

FIG. 6D is a side view of a motion ratio adjustment assembly according to an example embodiment in which the mounting assembly has been removed for illustrative purposes.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability, or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, the phrase “operable coupling” and variants thereof should be understood to relate to direct or indirect connection that, in either case, enables functional interconnection of components that are operably coupled to each other.

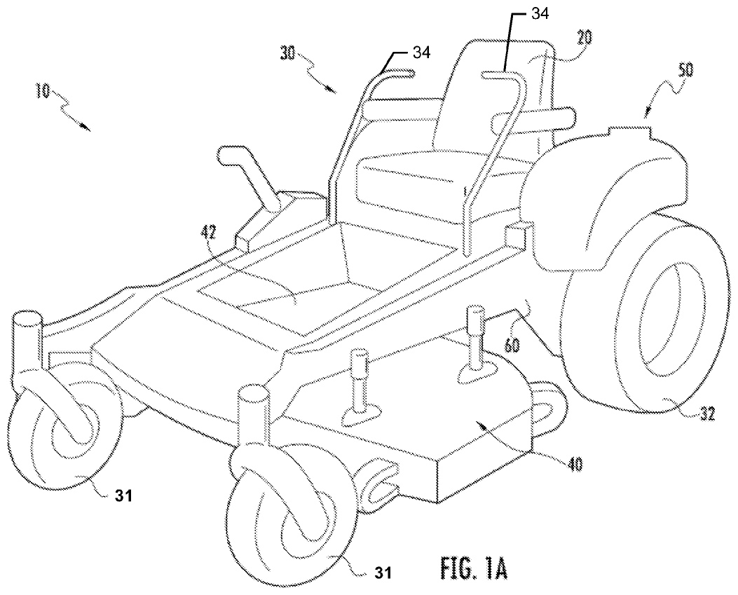

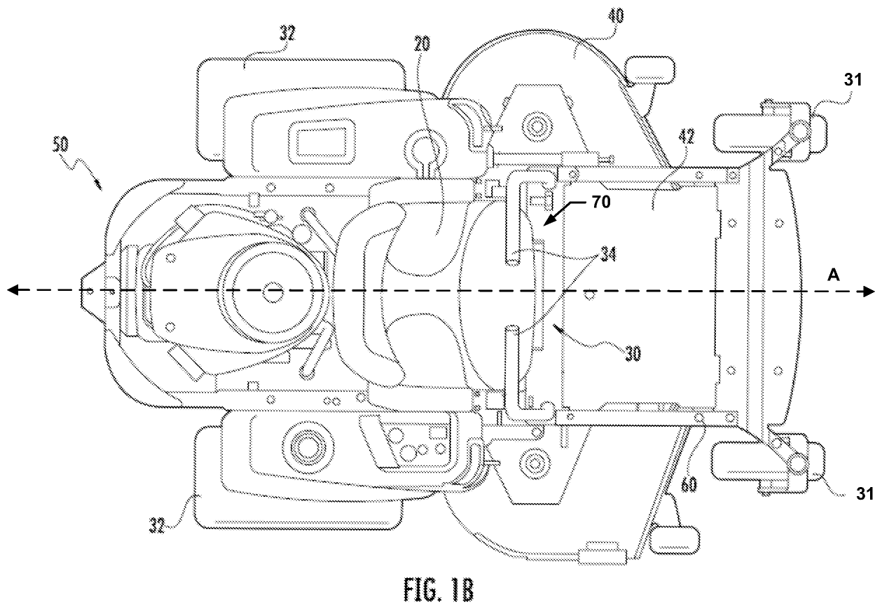

FIG. 1A illustrates a perspective view of a riding lawn care vehicle 10 and FIG. 1B illustrates a top view of the riding lawn care vehicle 10 according to an example embodiment. The riding lawn care vehicle 10 may include a seat 20 that may be disposed at a center, rear, or front portion of the riding lawn care vehicle 10. The riding lawn care vehicle 10 may also include a steering assembly 30 (e.g., a set of steering levers or the like) functionally connected to wheels 31 and/or 32 of the riding lawn care vehicle 10 to allow the operator to steer the riding lawn care vehicle 10.

In the depicted example, the operator may sit on the seat 20, which may be disposed between steering levers 34 of the steering assembly 30 to provide input for steering of the riding lawn care vehicle 10 via the steering assembly 30. The riding lawn care vehicle 10 may also include a cutting deck 40 having at least one cutting blade (e.g., three cutting blades) mounted therein. The cutting deck 40 may be positioned substantially rearward of a pair of front wheels 31 and substantially forward of a pair of rear wheels 32 in a position to enable the operator to cut grass using the cutting blade(s) when the cutting blade(s) are rotated below the cutting deck 40 when the cutting deck 40 is in a cutting position. However, in some alternative examples, the cutting deck 40 may be positioned in front of the front wheels 31.

In some embodiments, a footrest 42 may also be positioned above the cutting deck 40 forward of the seat 20 to enable the operator to rest his or her feet thereon while seated in the seat 20. In the pictured embodiment, an engine 50 of the riding lawn care vehicle 10 is disposed to the rear of a seated operator. However, in other example embodiments, the engine 50 could be in different positions such as in front of or below the operator. The engine 50 may be operably coupled to one or more of the wheels 31 and/or 32 (in this case only to the rear wheels 32) to provide drive power for the riding lawn care vehicle 10. The engine 50, the steering assembly 30, the cutting deck 40, the seat 20, and other components of the riding lawn care vehicle 10 may be operably connected (directly or indirectly) to a frame 60 of the riding lawn care vehicle 10. The frame 60 may be a rigid structure configured to provide support, connectivity, and/or interoperability functions for various ones of the components of the riding lawn care vehicle 10.

As can be appreciated from FIG. 1A, the footrest 42 may be substantially lower (in elevation) than the seat 20 in order to comfortably support a seated operator on the seat 20. This results in an elevated seat 20 that is disposed atop a seat mounting structure 70 that is operably coupled to the frame 60. Particularly when the engine 50 is disposed to the rear of the seat 20, the space under the seat 20 and behind/under the seat mounting structure 70 may be advantageously utilized for storage. Thus, it may be desirable to enable maximization of the space under the seat 20, and the ability to access such space, while still providing good isolation for the seat 20.

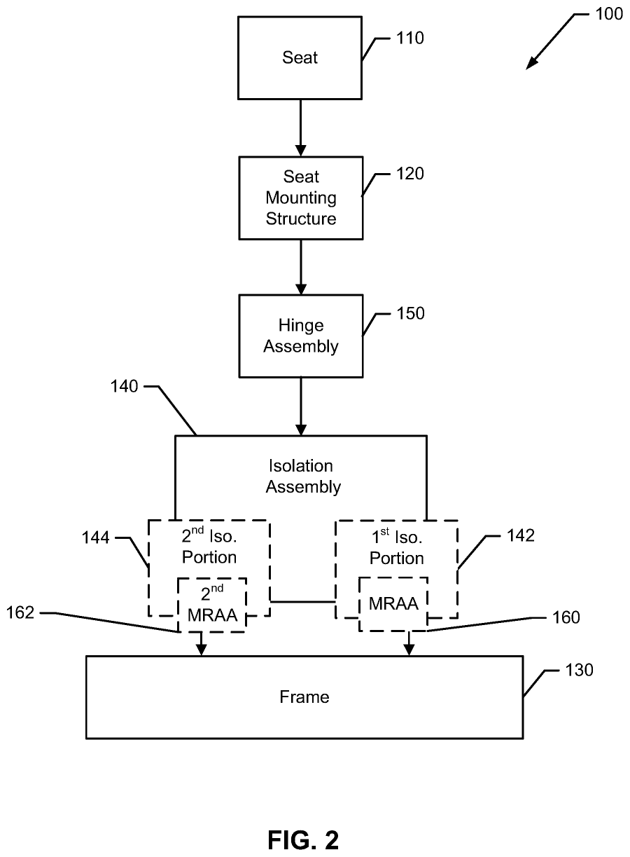

FIG. 2 illustrates a block diagram of a seat isolation system 100 according to an example embodiment. As shown in FIG. 2, the seat isolation system 100 may include a seat 110, seat mounting structure 120 and frame 130 (which may correspond to the seat 20, seat mounting structure 70 and frame 60 described above). The seat isolation system 100 may also include an isolation assembly 140 that is configured to isolate the seat 110 from vibrations communicated through the frame 130. The seat isolation system 100 may also include a hinge assembly 150 configured to enable the seat 110 to be moved from an in-use or operating position to a pivoted position, which may expose the area under the seat 110 to allow the operator access to the area under the seat 110 (e.g., for storage).

As shown in FIG. 2, the seat mounting structure 120 (and therefore also the seat 110) may have no direct connection to the frame 130. Instead, operable coupling of the seat 110 and seat mounting structure 120 to the frame 130 is only provided via the isolation assembly 140. Yet, the seat 110 is still movable between the operating position and the pivoted position due to the inclusion of the hinge assembly 150. Whereas the hinge assembly of a conventional design is typically a direct connection between the seat (or seat mounting structure) and the frame, the isolation assembly 140 of an example embodiment (or at least a portion thereof) is incorporated into the hinge assembly 150 so that even the hinge assembly 150 does not provide a path for direct coupling of vibration energy from the frame 130 to the seat.

The isolation assembly 140 of FIG. 2 may include a first isolation portion 142 associated with a first side of the seat 110 and/or seat mounting structure 120, and a second isolation portion 144 associated with a second side of the seat 110 or seat mounting structure 120. In an example embodiment, the hinge assembly 150 may define a pivot axis about which the seat 110 and the seat mounting structure 120 may pivot when transiting between the operating position and the pivoted position. The seat mounting structure 120 may also pivot about the pivot axis when the riding lawn care vehicle 10 goes over bumps. In this regard, the seat mounting structure 120 may be thought of as a cantilever, and the operator in the seat 110 may be thought of as a gravitational force applied to the cantilever. As such, the gravitational force from the operator may result in a displacement of the seat 110. The displacement of the seat 110 may induce a rotational moment of the seat mounting structure 120 at the pivot axis where it is rotationally operably coupled to the hinge assembly 150. The isolation assembly 140 may further include a motion ratio adjustment assembly (MRAA) 160 which may enable adjustment of the motion ratio of the isolation assembly 140. The motion ratio of the isolation assembly 140 may be defined as the ratio of the amount of displacement of the seat 110 to the amount of compression of a spring. To the extent the isolation assembly 140 is operably coupled with the hinge assembly 150, adjustment may also impact the hinge assembly 150 in some cases. In some embodiments, the isolation assembly 140 may also include a second MRAA 162 that may mirror the MRAA 160 at an opposite end of a seat interface. The seat interface and the MRAA 160 will be discussed in further detail below in reference to later figures.

In some embodiments, the seat 110 pivots forward or rearward with respect to the direction of motion of the riding lawn care vehicle 10. In such cases, the pivot axis may extend laterally across the riding lawn care vehicle 10 (i.e., substantially perpendicular to the longitudinal axis or longitudinal centerline of the riding lawn care vehicle 10) at either a front side (e.g., the first side) of the seat 110 or seat mounting structure 120 (for a forward pivot) or a rear side (e.g., the second side) of the seat 110 or seat mounting structure 120 (for a rearward pivot). Similarly, for a pivot of the seat 110 or seat mounting structure 120 to the right or left, the pivot axis would extend parallel to the longitudinal axis of the vehicle, and be located on the same lateral side of the vehicle as the pivot direction.

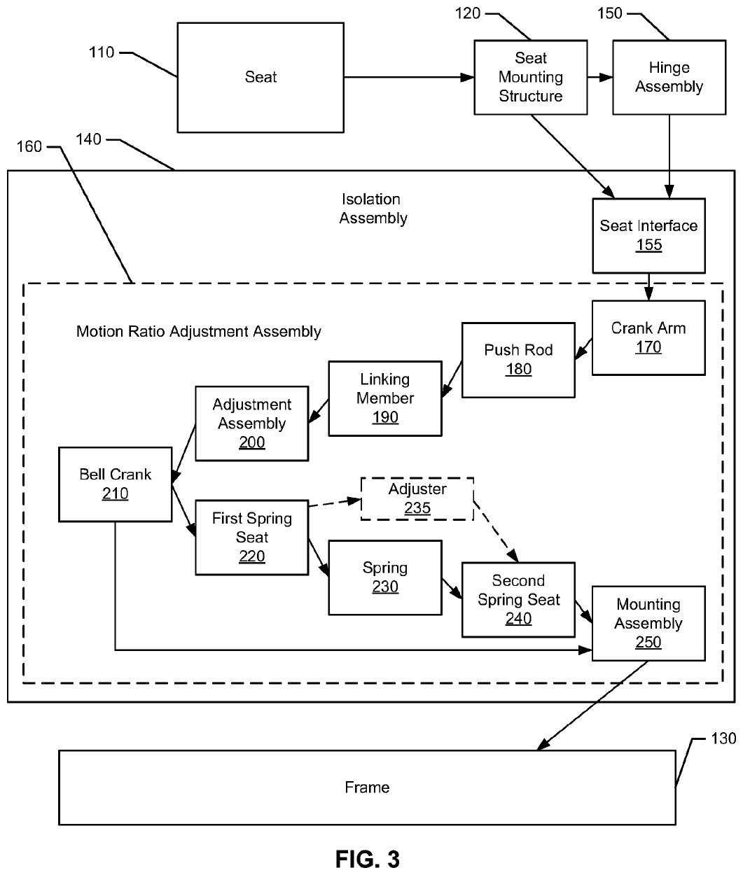

FIG. 3 illustrates a block diagram of a motion ratio adjustment assembly (MRAA) 160 according to an example embodiment. As seen in FIG. 3, the MRAA 160 may include a crank arm 170, a push rod 180, a linking member 190, an adjustment assembly 200, a bell crank 210, a first spring seat 220, a spring 230, a second spring seat 240 and a mounting assembly 250. In some embodiments, the isolation assembly 140 may include a seat interface 155. The seat interface 155 may operably couple the MRAA 160 to the seat mounting structure 120 and to the hinge assembly 150. In this regard, the seat interface 155 may be a rod that may extend perpendicular to the longitudinal axis of the riding lawn care vehicle 10. The seat interface 155 may be fixedly operably coupled to the seat mounting structure 120 and rotational operably coupled to the hinge assembly 150. Therefore, the cylindrical rod shape of the seat interface 155 may allow it to transfer rotational motion with greater efficiency. In some cases, the seat interface 155 may have a sliding fit with brackets of the hinge assembly 150 such that the seat interface 155 may be enabled to rotate with respect to the hinge assembly 150. Additionally, the seat interface 155 may fixedly operably couple the MRAA 160 with the second MRAA 162. The MRAA 160 and the second MRAA 162 may be identical to each other, and may be disposed at opposite ends of the seat interface 155.

The crank arm 170 may be fixedly operably coupled to the seat interface 155 at a first end of the crank arm 170, and to the push rod 180 at a second end. In this regard, the seat interface 155 may translate the rotational motion induced by the seat mounting structure 120 (which may be caused by the displacement of the seat 110) to the crank arm 170. The crank arm 170 may then translate the rotational motion from the seat interface 155 into linear motion of the push rod 180. The push rod 180 may then transfer the linear motion to the adjustment assembly 200 via the linking member 190 which may operably couple the push rod 180 to the adjustment assembly 200.

In some embodiments, the adjustment assembly 200 may comprise a lever arm operably coupled to a side of a bell crank 210. In this regard, the adjustment assembly 200 may translate the linear motion of the push rod 180 into rotational motion of the bell crank 210 utilizing effectively the same principle regarding cantilevers as described above with respect to the seat mounting structure 120. The bell crank 210 may also be operably coupled to the first spring seat 220 which may be operably coupled to the spring 230. At an opposite end of the spring 230 from the first spring seat 220, there may be a second spring seat 240 which may also be operably coupled to the spring 230. Additionally, both the bell crank 210 and the second spring seat 240 may be operably coupled to the mounting assembly 250. The mounting assembly 250 may form a direct or an indirect fixed operable connection to the frame 130.

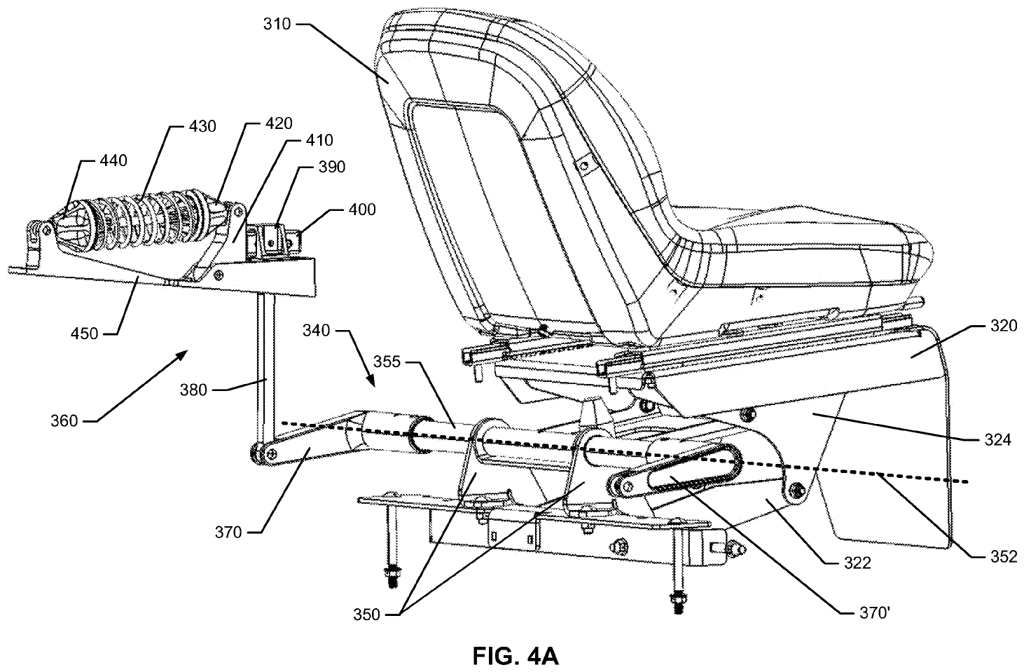

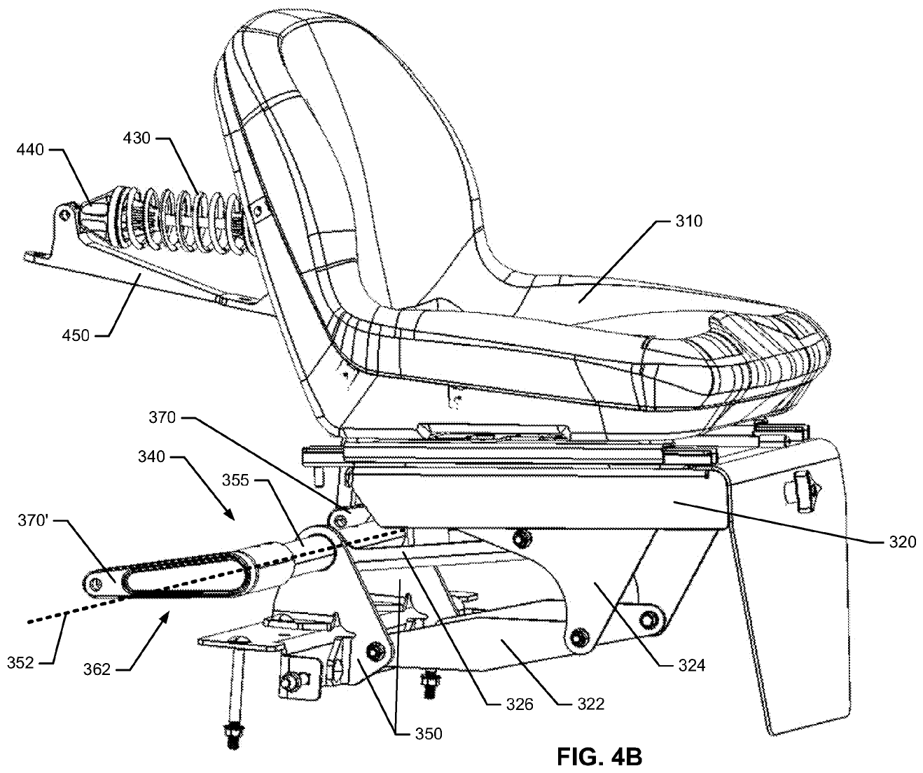

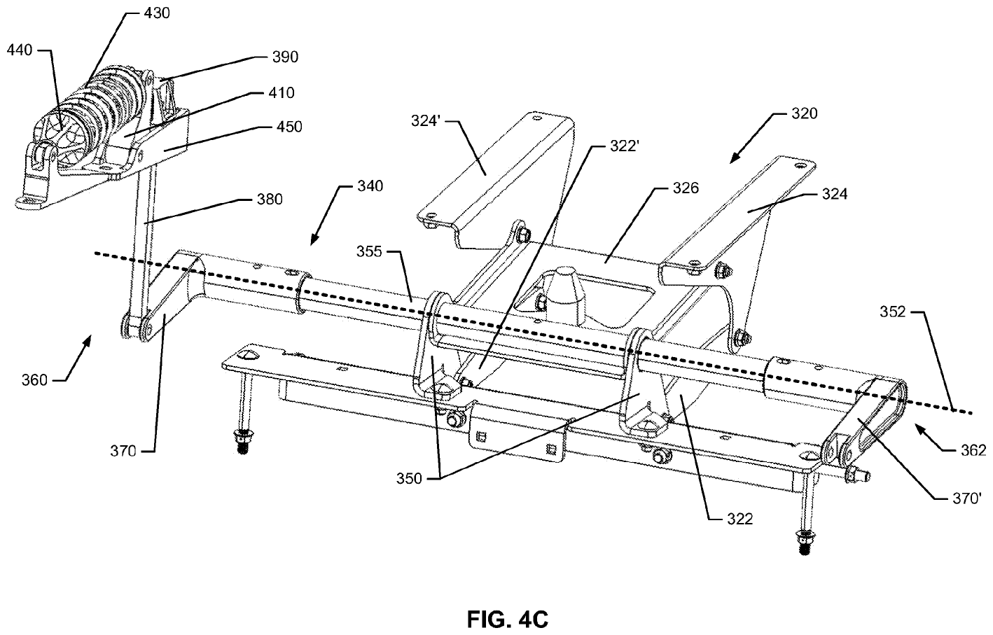

FIGS. 4A and 4B illustrate perspective views of the seat 310, seat mounting structure 320, isolation assembly 340, and the hinge assembly 350 according to an example embodiment. In the example embodiment of FIGS. 4A and 4B, the seat mounting structure 320 may comprise a four bar linked suspension. Lower suspension member 322 and upper suspension member 324 may comprise two of the four components of the four bar linked suspension of the seat mounting structure 320. In this regard, the lower suspension member 322 and the upper suspension member 324 may be disposed on a first side of the base underneath where the operator may sit in the seat 310. A second lower suspension member 322′ and a second upper suspension member 324′ may be disposed on a second side of the base underneath where the operator may sit in the seat 310. In some embodiments, the first and the second sides comprising the four bar linked suspension may be substantially parallel with each other, and also substantially parallel to the direction that an operator may face while positioned in the seat 310. In this regard, the first side and the second side of the four bar linked suspension may be symmetric about the longitudinal axis of the riding lawn care vehicle 10. As shown in FIGS. 4A and 4B, the seat mounting structure 320 may sometimes be embodied as a four bar linked suspension, but it should be appreciated that other embodiments may include other forms of linked suspension structures outside of the four bar type.

The four bar linked suspension of the seat mounting structure 320 may enable the pivoting of the seat 310 about the pivot axis 352. The pivot axis 352 may be coaxial with the longitudinal axis of the seat interface 355. Additionally, as shown in FIG. 4B, the lower suspension member 322 and the upper suspension member 324 may be pivotably connected to each other, the upper suspension member 324 may be pivotably connected to a stability plate 326, and the lower suspension member 322 may be pivotably connected to the hinge assembly 350. The motion ratio adjustment assembly 360 is also visible in FIG. 4A, and partially visible in FIG. 4B, but will be described in further detail below with respect to later figures.

FIG. 4C illustrates a perspective view of part of the seat mounting structure 320, the isolation assembly 340, and the hinge assembly 350 according to an example embodiment. In FIG. 4C, the seat 310 and part of the seat mounting structure 320 have been removed to allow for a better view of the remaining seat mounting structure 320. In some embodiments, the seat mounting structure 320 may further comprise a stability plate 326. The stability plate 326 may be pivotably operably coupled to the upper suspension member 324, and fixedly operably coupled to the isolation assembly 340 via the seat interface 355. The stability plate 326 may be disposed underneath the base of the seat 310 and may operably couple the seat 310 to the isolation assembly 340. In other words, responsive to the seat 310 being displaced, the stability plate 326 may cause the seat interface 355 to rotate about the pivot axis 352 via a rotational operable coupling to the hinge assembly 350. As such, the stability plate 326 effectively translates displacement of the seat 310 into rotational motion of the seat interface 355 via the hinge assembly 350. Therefore, the stability plate 326 may also be responsible for translating the displacement of the seat 310 into rotational motion of the crank arm 370 of the motion ratio adjustment assembly 360. In addition, the stability plate 326 may stabilize the upper suspension member 324 and the second upper suspension member 324′ of the four bar linked suspension, and define a distance by which each member is separated from each other.

In some embodiments, the stability plate 326 may pivot relative to the hinge assembly 350, but may be fixed relative to the seat interface 355 and the crank arm 370. In other words, all of the rotational motion of the stability plate 326 about the pivot axis 352 may be transferred to the motion ratio adjustment assembly 360 via the seat interface 355. In this regard, the seat interface 355 may extend through the brackets of the hinge assembly 350 such that the seat interface 355 and the hinge assembly 350 are rotationally operably coupled. In some embodiments, the seat interface 355 may also be fixedly operably coupled to a second crank arm 370′ which may further be operably coupled to a second MRAA 362. The second crank arm 370′ and the second MRAA 362 may be disposed at an opposite end of the seat interface 355 from the crank arm 370 and the MRAA 360. In some embodiments, the second MRAA 362 may be identical to the MRAA 360 with regards to its components, linkages, and functionality.

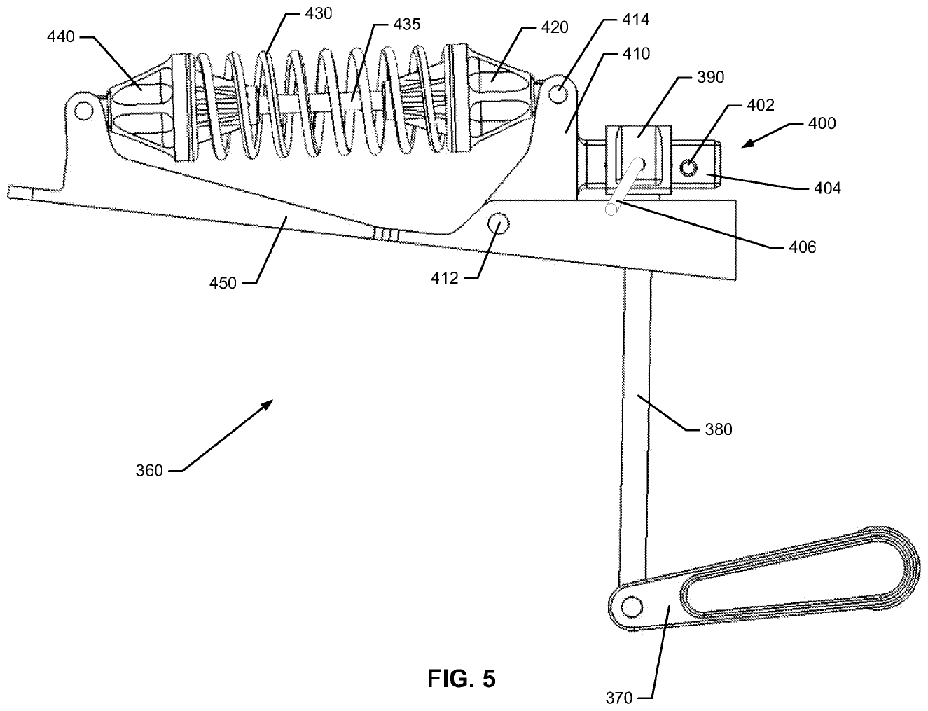

FIG. 5 shows a side view of a motion ratio adjustment assembly 360 according to an example embodiment. As previously described, in some embodiments the MRAA 360 may comprise a crank arm 370, a push rod 380, a linking member 390, an adjustment assembly 400, a bell crank 410, a first spring seat 420, a spring 430, a second spring seat 440 and a mounting assembly 450. The crank arm 370 may be fixedly operably coupled to the seat interface 355 such that displacement of the seat 310 is translated to the motion ratio adjustment assembly 360 by way of the stability plate 326, the seat interface 355 and the hinge assembly 350. The crank arm 370 may be pivotably operably coupled to the push rod 380 such that the motion of the crank arm 370 is translated into linear motion of the push rod 380. At the opposite end of the push rod 380 from the pivotable connection to the crank arm 370 there may be a second pivotable connection to the linking member 390. The linking member 390 may be pivotably operably coupled to the push rod 380 as well as slidably operably coupled to the adjustment assembly 400. The push rod 380 may thereby move the adjustment assembly 400 up and down due to the forces imparted on the push rod 380 by the crank arm 370.

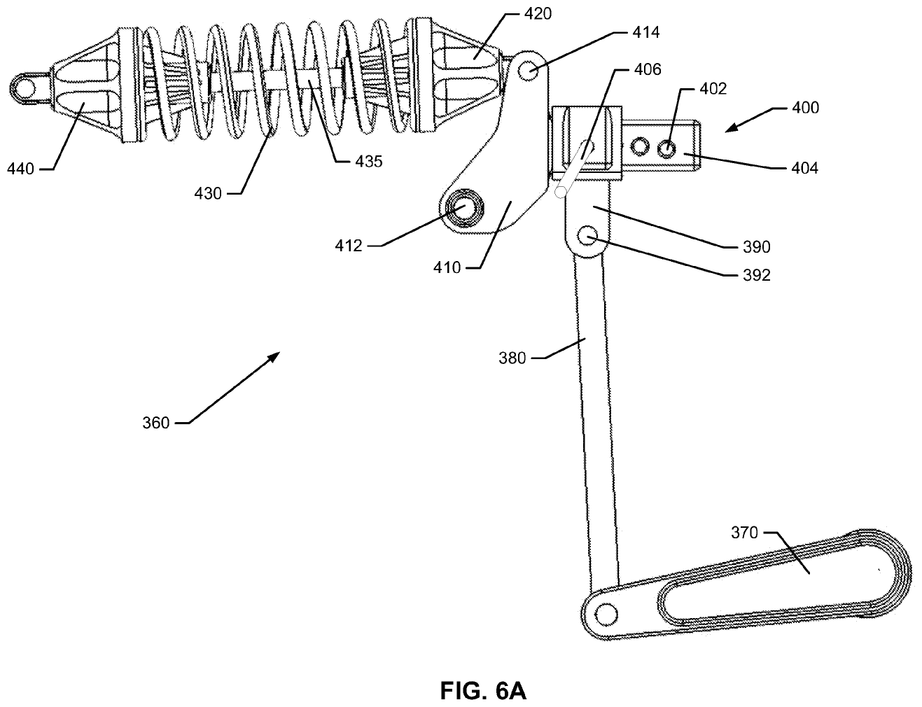

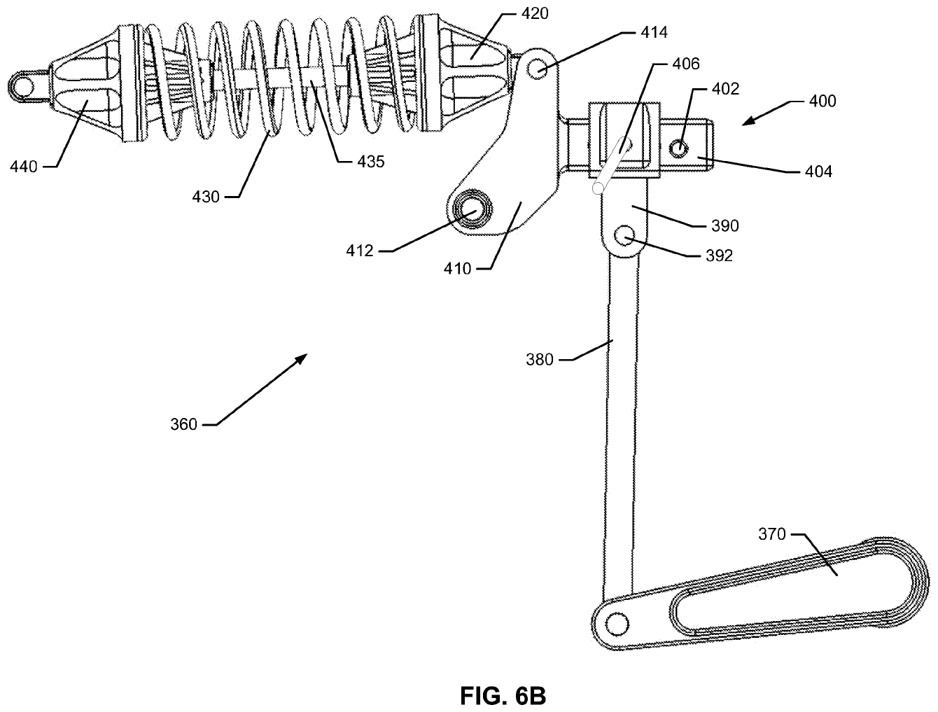

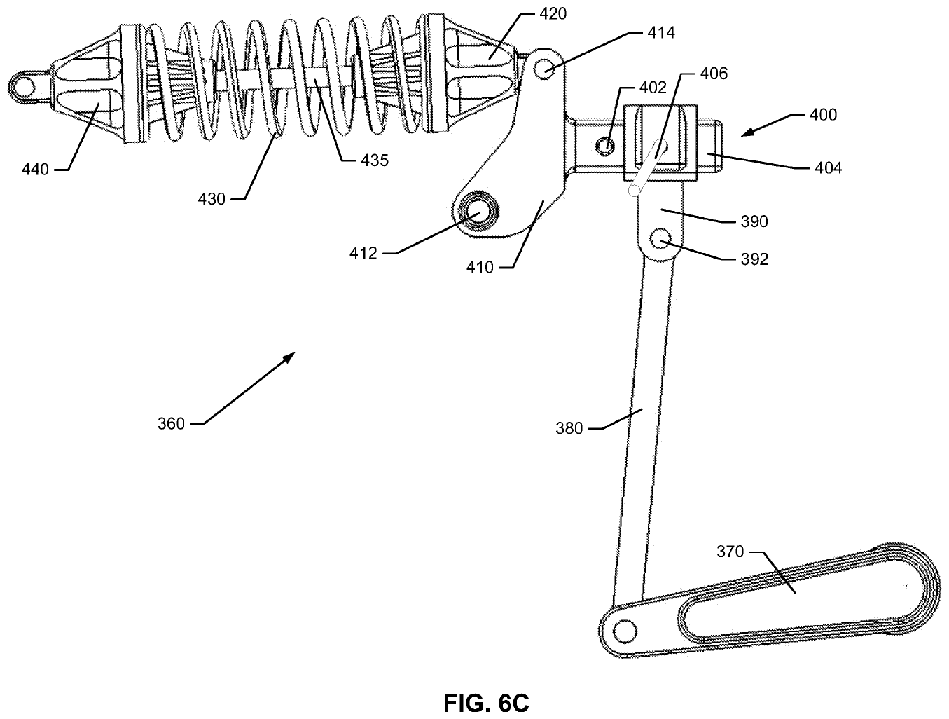

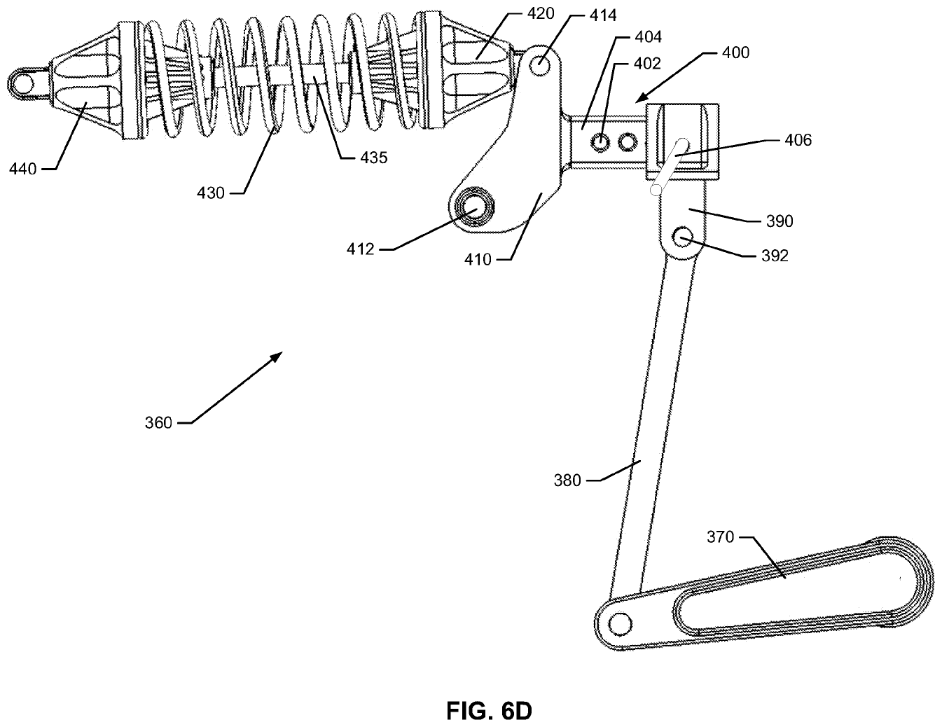

The adjustment assembly 400 may include a plurality of holes 402 disposed along the length of a lever arm 404 and a corresponding pin 406. The lever arm 404 of the adjustment assembly 400 may extend substantially perpendicularly out from a side of the bell crank 410. In this regard, the push rod 380 may apply a force at a particular location along the length of the lever arm 404 at which the linking member 390 may be operably coupled to the lever arm 404. The linking member 390 may be secured to the lever arm 404 by inserting the pin 406 through the linking member 390 and also through one of the plurality of holes 402. Thus, dependent upon which hole 402 the linking member 390 is secured to, the effective length of the lever arm 404 of the adjustment assembly 400 may be changed as depicted in FIGS. 6A-6D and described later on in reference to these figures.

In some embodiments, the bell crank 410 may be pivotably operably coupled to the mounting assembly 450 at a lower pivot point 412. Accordingly, the bell crank 410 may rotate about the lower pivot point 412 responsive to receiving a force on the lever arm 404 of the adjustment assembly 400 from the push rod 380. The resulting rotation of the bell crank 410 about lower pivot point 412 may, in turn, apply a force on the first spring seat 420 (and therefore the spring 430) via an upper pivot point 414. Therefore, by way of rotation of the bell crank 410, the force from the push rod 380 that may be applied to the lever arm 404, may also be transferred to the spring 430 via the bell crank 410 and the first spring seat 420. The second spring seat 440 may be operably coupled to the mounting assembly 450 and therefore fixed in place due to being operably coupled to the frame 130. As such, compressing the spring 430 may involve the first spring seat 420 moving closer to the second spring seat 440. In other words, displacement of the seat 310 is effectively dampened by the spring 430 through transferring forces from the seat, to the stability plate 326, to the seat interface 355, to the crank arm 370, to the push rod 380, to the adjustment assembly 400, to the bell crank 410 and finally to the spring 430.

In some embodiments, the first spring seat 420 and the second spring seat 440 may be adjustable in order to define a pre-loaded compression of the spring 430. Accordingly, there may be an adjuster 435 which may operably couple the first spring seat 420 to the second spring seat 440. The adjuster 435 may define a distance between the first spring seat 420 and the second spring seat 440, thereby defining the pre-loaded compression of the spring 430. In other words, when the motion ratio adjustment assembly 360 is in a resting state (indicating that all forces are negligible) an operator may be able to tighten or loosen the adjuster 435 with respect to the first spring seat 420 and the second spring seat 440 which may put the spring 430 under a selected level of pre-loaded compression prior to any application of external forces from the MRAA 360. Pre-loading the spring 430 by tightening the adjuster 435 relative to the first spring seat 420 and the second spring seat 440 may reduce the distance between the first spring seat 420 and the second spring seat 440, making the isolation assembly 340 stiffer and perhaps better suited to the heavier operator. Loosening the adjuster 435 with respect to the first spring seat 420 and the second spring seat 440 may increase the distance between the first spring seat 420 and the second spring seat 440, making the isolation assembly 340 softer and perhaps better suited to the lighter operator. In some embodiments however, the spring 430 may not be capable of being pre-loaded with any amount of compression. Crucially, as discussed in the background, pre-loading the spring 430 may not be the most effective method of tuning the isolation assembly 340 for operators who may be on either extreme end of the weight spectrum (i.e. very light or very heavy).

FIGS. 6A-6D illustrate a side view of the motion ratio adjustment assembly 360 according to an example embodiment. In FIGS. 6A-6D, the mounting assembly 450 has been removed to better describe the push rod 380, the linking member 390, and the adjustment assembly 400. In some embodiments, the linking member may comprise a first connection point 392 and a second connection point through which the pin 406 may be inserted. The first connection point 392 may be pivotably operably coupled to the push rod 380. The pivotable operable coupling of the linking member 390 and the push rod 380 may allow for the push rod 380 to exert forces on the linking member 390 from a plurality of different angles and orientations. The second connection point of the linking member 390 may be slidably operably coupled to the lever arm 404 and may accommodate the pin 406. In this regard, the lever arm 404 may comprise a plurality of holes 402 along a length of the lever arm 404. In some embodiments, the linking member 390 may slide along the lever arm 404 until the second connection point aligns with any one of the plurality of holes 402 such that the pin 406 can be inserted through both the second connection point and the hole 402 to secure the linking member 390 to the lever arm 404 of the adjustment assembly 400. In some embodiments, the adjustment assembly 400 may comprise four holes 402 for adjusting the linking member 390, representing four different effective lengths for the lever arm 404 to embody. Changing which hole 402 the linking member 390 may be secured to may change the effective length of the lever arm 404 of the adjustment assembly 400. For example, FIG. 6A depicts the linking member 390 in a position on the adjustment assembly 400 with the shortest possible effective length for the depicted embodiment. As with any other lever in the real world, a longer lever arm 404 may require less force from the push rod 380 to result in motion of the bell crank 410 than a shorter lever arm 404 would. This is a well-known physical property which explains why the length of the levers on objects like vehicle jacks are much longer than levers on objects like hand wrenches. As such, FIG. 6A depicts the stiffest setting for the MRAA 360. In FIG. 6D, the linking member 390 is positioned at the hole 402 that may be furthest away from the bell crank 410. In this regard, the effective length of the lever arm 404 may be in its longest configuration possible in the depicted embodiment. Thus, the force required to compress the spring 430 when the linking member 390 is in the position depicted in FIG. 6D may be less than the force required to compress the spring 430 by the same amount with the linking member 390 in any of the positions depicted in FIGS. 6A-6C. Therefore, FIG. 6D may depict the loosest setting for the MRAA 360.

Accordingly, adjusting the location of the linking member 390 effectively adjusts the motion ratio of the isolation assembly 340. As described above, the motion ratio of the isolation assembly 340 may be defined as the ratio of an amount of displacement of the seat 310 to an amount of compression of the spring 430

$$( \frac{displacement of seat}{compression of spring} ) .$$

For example, assume the displacement of the seat 310 in each of FIGS. 6A-6D is the same, merely for the purpose of explanation. With a constant displacement of the seat 310, the force transferred through the seat interface 355 to the crank arm 370 and thus to the adjustment assembly 400 is also constant. Therefore, the only variable value in FIGS. 6A-6D may be the location of the linking member 390 on the lever arm 404. For the same amount of force applied to the adjustment assembly 400, the configuration in FIG. 6A may compress the spring 430 the least and therefore the motion ratio may be the largest. Working from FIG. 6B to FIG. 6C and finally to FIG. 6D, the motion ratio may decrease in each figure because the compression of the spring 430 may be greater in each figure for the same amount of force applied to the adjustment assembly 400 from the displacement of the seat 310.

Some example embodiments may provide for an isolation assembly enabling vibration isolation for a seat of a riding lawn care vehicle. The isolation assembly may include a motion ratio adjustment assembly to define a motion ratio of the isolation assembly independent of an amount of pre-loaded compression, and a seat interface configured to transfer displacement of the seat to the motion ratio adjustment assembly. The seat may be operably coupled to a seat mounting structure. The isolation assembly may be operably coupled to the seat mounting structure via a hinge assembly such that displacement of the seat may be transferred to the isolation assembly via the hinge assembly.

The isolation assembly of some embodiments may include additional, optional features, and/or the features described above may be modified or augmented. Some examples of modifications, optional features and augmentations are described below. It should be appreciated that the modifications, optional features and augmentations listed below may each be added alone, or they may be added cumulatively in any desirable combination. For example, in some embodiments, the motion ratio adjustment assembly may be disposed on a first side of the seat, and a second motion ratio adjustment assembly may be disposed at a second side of the seat opposite the first side. In some cases, the motion ratio adjustment assembly and the second motion ratio adjustment assembly may be operably coupled at opposite ends of the seat interface. In an example embodiment, the motion ratio adjustment assembly may include a mounting assembly which may be operably coupled to a frame of the riding lawn care vehicle, a bell crank which may be pivotably operably coupled to the mounting assembly, a first spring seat which may be operably coupled to the bell crank, a second spring seat which may be operably coupled to the mounting assembly and disposed a distance away from the first spring seat, and a spring which may be operably coupled to the first and second spring seats at respective opposing ends of the spring. In some cases, the first and second spring seats may be disposed a fixed distance apart from each other such that the spring may have a fixed pre-loaded compression. In an example embodiment, the first and second spring seats may be disposed an adjustable distance from each other to define a change in pre-loaded compression of the spring based on changing the adjustable distance. In some cases, the motion ratio adjustment assembly may further include a crank arm which may translate rotational motion into linear motion, an adjustment assembly which may be operably coupled to the bell crank, a push rod which may transfer the linear motion of the crank arm to the adjustment assembly, and a linking member which may be operably couple the push rod to the adjustment assembly. In an example embodiment, the crank arm may pivot responsive to the seat interface being rotated. In some cases, the seat interface may rotate responsive to the seat being displaced. In an example embodiment, the adjustment assembly may include a lever arm which may operably couple the bell crank to the push rod via the linking member. In some cases, the linking member may be secured to one of a plurality of locations along a length of the lever arm. In an example embodiment, the adjustment assembly may be adjustable to define an effective length of the lever arm such that the isolation assembly may be stiffer when the effective length is shorter and looser when the effective length is longer. In some cases, the push rod may extend in a first direction, and the spring may extend in a second direction substantially perpendicular to the first direction. In an example embodiment, the adjustment assembly may further include a plurality of holes with which the linking member may align, and a pin which may operably couple the linking member to the lever arm via one of the plurality of holes.

Some example embodiments may provide for a riding lawn care vehicle. The riding lawn care vehicle may include a frame to which wheels of the riding lawn care vehicle may be attachable, a seat which an operator of the riding lawn care vehicle may utilize when operating the riding lawn care vehicle, a seat mounting structure to which the seat may be mounted, an isolation assembly which may provide vibration isolation between the frame and the seat mounting structure, and a hinge assembly which may enable the seat to pivot via the seat mounting structure. The isolation assembly may include a motion ratio adjustment assembly which may define a motion ratio of the isolation assembly independent of an amount of pre-loaded compression. The isolation assembly may be operably coupled to the seat mounting structure via the hinge assembly such that displacement of the seat may be transferred to the isolation assembly via the hinge assembly.

The riding lawn care vehicle of some embodiments may include additional, optional features, and/or the features described above may be modified or augmented. Some examples of modifications, optional features and augmentations are described below. It should be appreciated that the modifications, optional features and augmentations listed below may each be added alone, or they may be added cumulatively in any desirable combination. For example, in some embodiments, the motion ratio adjustment assembly may be disposed on a first side of the seat, and a second motion ratio adjustment assembly may be disposed at a second side of the seat opposite the first side. In some cases, the motion ratio adjustment assembly and the second motion ratio adjustment assembly may be operably coupled at opposite ends of the seat interface. In an example embodiment, the motion ratio adjustment assembly may include a mounting assembly which may be operably coupled to a frame of the riding lawn care vehicle, a bell crank which may be pivotably operably coupled to the mounting assembly, a first spring seat which may be operably coupled to the bell crank, a second spring seat which may be operably coupled to the mounting assembly and disposed a distance away from the first spring seat, and a spring which may be operably coupled to the first and second spring seats at respective opposing ends of the spring. In some cases, the first and second spring seats may be disposed a fixed distance apart from each other such that the spring may have a fixed pre-loaded compression. In an example embodiment, the first and second spring seats may be disposed an adjustable distance from each other to define a change in pre-loaded compression of the spring based on changing the adjustable distance. In some cases, the motion ratio adjustment assembly may further include a crank arm which may translate rotational motion into linear motion, an adjustment assembly which may be operably coupled to the bell crank, a push rod which may transfer the linear motion of the crank arm to the adjustment assembly, and a linking member which may be operably couple the push rod to the adjustment assembly. In an example embodiment, the crank arm may pivot responsive to the seat interface being rotated. In some cases, the seat interface may rotate responsive to the seat being displaced. In an example embodiment, the adjustment assembly may include a lever arm which may operably couple the bell crank to the push rod via the linking member. In some cases, the linking member may be secured to one of a plurality of locations along a length of the lever arm. In an example embodiment, the adjustment assembly may be adjustable to define an effective length of the lever arm such that the isolation assembly may be stiffer when the effective length is shorter and looser when the effective length is longer. In some cases, the push rod may extend in a first direction, and the spring may extend in a second direction substantially perpendicular to the first direction. In an example embodiment, the adjustment assembly may further include a plurality of holes with which the linking member may align, and a pin which may operably couple the linking member to the lever arm via one of the plurality of holes.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits, or solutions to problems are described herein, it should be appreciated that such advantages, benefits, and/or solutions may be applicable to some example embodiments, but not necessarily all example embodiments. Thus, any advantages, benefits, or solutions described herein should not be thought of as being critical, required, or essential to all embodiments or to that which is claimed herein. Although specific terms are employed herein, they are used in a generic and descriptive sense only and not for purposes of limitation.

1. An isolation assembly providing vibration isolation for a seat of a riding lawn care vehicle, the isolation assembly comprising:
a motion ratio adjustment assembly configured to define a motion ratio of the isolation assembly independent of an amount of pre-loaded compression; and
a seat interface configured to transfer displacement of the seat to the motion ratio adjustment assembly,
wherein the seat is operably coupled to a seat mounting structure, and
wherein the isolation assembly is operably coupled to the seat mounting structure via a hinge assembly such that displacement of the seat is transferred to the isolation assembly via the hinge assembly.

2. The isolation assembly of claim 1, wherein the motion ratio adjustment assembly is disposed on a first side of the seat,
wherein the isolation assembly comprises a second motion ratio adjustment assembly disposed at a second side of the seat opposite the first side, and
wherein the motion ratio adjustment assembly and the second motion ratio adjustment assembly are operably coupled at opposite ends of the seat interface.

3. The isolation assembly of claim 1, wherein the motion ratio adjustment assembly comprises:
a mounting assembly operably coupled to a frame of the riding lawn care vehicle;
a bell crank pivotably operably coupled to the mounting assembly;
a first spring seat operably coupled to the bell crank;
a second spring seat operably coupled to the mounting assembly and disposed a distance away from the first spring seat; and
a spring operably coupled to the first and second spring seats at respective opposing ends of the spring.

4. The isolation assembly of claim 3, wherein the first and second spring seats are disposed a fixed distance apart from each other such that the spring has a fixed pre-loaded compression.

5. The isolation assembly of claim 3, wherein the first and second spring seats are disposed an adjustable distance from each other to define a change in pre-loaded compression of the spring based on changing the adjustable distance.

6. The isolation assembly of claim 3, wherein the motion ratio adjustment assembly further comprises:
a crank arm configured to translate rotational motion into linear motion;
an adjustment assembly operably coupled to the bell crank;
a push rod configured to transfer the linear motion of the crank arm to the adjustment assembly; and
a linking member operably coupling the push rod to the adjustment assembly,
wherein the crank arm pivots responsive to the seat interface being rotated, and
wherein the seat interface rotates responsive to the seat being displaced.

7. The isolation assembly of claim 6, wherein the adjustment assembly comprises a lever arm operably coupling the bell crank to the push rod via the linking member, and
wherein the linking member can be secured to one of a plurality of locations along a length of the lever arm.

8. The isolation assembly of claim 7, wherein the adjustment assembly is adjustable to define an effective length of the lever arm such that the isolation assembly is stiffer when the effective length is shorter and looser when the effective length is longer.

9. The isolation assembly of claim 6, wherein the push rod extends in a first direction, and
wherein the spring extends in a second direction substantially perpendicular to the first direction.

10. The isolation assembly of claim 7, wherein the adjustment assembly further comprises a plurality of holes with which the linking member may are alignable, and a pin to operably couple the linking member to the lever arm via one of the plurality of holes.

11. A riding lawn care vehicle comprising:
a frame to which wheels of the riding lawn care vehicle are attachable;
a seat for an operator of the riding lawn care vehicle to utilize when operating the riding lawn care vehicle;
a seat mounting structure to which the seat is mounted;
an isolation assembly providing vibration isolation between the frame and the seat mounting structure; and
a hinge assembly configured to enable the seat to pivot via the seat mounting structure,
wherein the isolation assembly comprises a motion ratio adjustment assembly configured to define a motion ratio of the isolation assembly independent of an amount of pre-loaded compression, and
wherein the isolation assembly is operably coupled to the seat mounting structure via the hinge assembly such that displacement of the seat is transferred to the isolation assembly via the hinge assembly.

12. The riding lawn care vehicle of claim 11, wherein the motion ratio adjustment assembly is disposed on a first side of the seat, and wherein the isolation assembly comprises a second motion ratio adjustment assembly disposed at a second side of the seat opposite the first side.

13. The riding lawn care vehicle of claim 11, wherein the motion ratio adjustment assembly comprises:
a mounting assembly operably coupled to a frame of the riding lawn care vehicle;
a bell crank pivotably operably coupled to the mounting assembly;
a first spring seat operably coupled to the bell crank;
a second spring seat operably coupled to the mounting assembly and disposed a distance away from the first spring seat; and
a spring operably coupled to the first and second spring seats at respective opposing ends of the spring.

14. The riding lawn care vehicle of claim 13, wherein the first and second spring seats are disposed a fixed distance apart from each other such that the spring has a fixed pre-loaded compression.

15. The riding lawn care vehicle of claim 13, wherein the first and second spring seats are disposed an adjustable distance from each other to define a change in pre-loaded compression of the spring based on changing the adjustable distance.

16. The riding lawn care vehicle of claim 13, wherein the motion ratio adjustment assembly further comprises:
a crank arm configured to translate rotational motion into linear motion;
an adjustment assembly operably coupled to the bell crank;
a push rod configured to transfer the linear motion of the crank arm to the adjustment assembly; and
a linking member operably coupling the push rod to the adjustment assembly,
wherein the crank arm pivots responsive to the seat interface being rotated, and
wherein the seat interface rotates responsive to the seat being displaced.

17. The riding lawn care vehicle of claim 16, wherein the adjustment assembly comprises a lever arm operably coupling the bell crank to the push rod via the linking member, and
wherein the linking member can be secured to one of a plurality of locations along a length of the lever arm.

18. The riding lawn care vehicle of claim 17, wherein the adjustment assembly is adjustable to define an effective length of the lever arm such that the isolation assembly is stiffer when the effective length is shorter and looser when the effective length is longer.

19. The riding lawn care vehicle of claim 16, wherein the push rod extends in a first direction, and
wherein the spring extends in a second direction substantially perpendicular to the first direction.

20. The riding lawn care vehicle of claim 17, wherein the adjustment assembly further comprises a plurality of holes with which the linking member is alignable, and a pin to operably couple the linking member to the lever arm via one of the plurality of holes.
